(19) United States
(12) Patent Application Publication
(10) Pub. No.: US 2025/0033945 A1
(43) Pub. Date: Jan. 30, 2025

(54) AUTOMATIC BEVERAGE CAN OPENER

(71) Applicant: DISPENSION INDUSTRIES INCORPORATED, DARTMOUTH (CA)

(72) Inventors: GORAN MARKOVIC, TORONTO (CA); GILLES ALAIN MARTIN GRANT RUMFELS, NORTH YORK (CA); MILOS BALJOZOVIC, TORONTO (CA); YU SONG MATTHEW XIE, MARKHAM (CA); COREY YANTHA, DARTMOUTH (CA); MATTHEW MICHAELIS, DARTMOUTH (CA)

(21) Appl. No.: 18/836,789

(22) PCT Filed: Feb. 13, 2023
(86) PCT No.: PCT/CA2023/050184

§ 371 Date: Aug. 8, 2024

Related U.S. Application Data
(60) Provisional application No. 63/309,487, filed on Feb. 11, 2022.

(51) Int. Cl. B67B 7/40; G07F 11/72

(52) U.S. Cl. CPC B67B 7/40; G07F 11/72

(57) ABSTRACT

Disclosed herein is an automatic beverage can opener. As an example, provided is an automatic beverage can opener comprising: a lever, the lever being automated and movable about a lever pivot axis; a wedge mechanism that is rotatably interconnected to the lever, the wedge mechanism comprising a tab engagement finger; and a can holder for positioning a beverage can in a position where a tab thereof can be engaged by the tab engagement finger upon automated movement of the lever.

### CROSS-REFERENCE TO RELATED APPLICATION

This application claims priority to and benefit from U.S. Patent Application Ser. No. 63/309,487 filed on Feb. 11, 2022, which is hereby incorporated by reference in its entirety.

### TECHNICAL FIELD

The present disclosure generally relates to an automatic beverage can opener, and in particular to an automatic beverage can opener for use in a vending or other dispensing machine.

### BACKGROUND

The use of cans for the storage and distribution of ready-to-drink beverages (e.g. juices, energy drinks, beer, cocktails, cannabis drinks, etc.) is common. Likewise, vending machines are a useful and practical means of distributing and/or selling canned beverages.

Industry best-practice for serving canned beverages in sports stadiums requires that beverages be opened prior to being served. The intent behind this practice is threefold: (1) to ensure that canned beverages are depressurized to reduce harm if used as a projectile; (2) to ensure that closed beverages purchased outside of the facility are not snuck inside; and (3) to ensure that beverages purchased inside the facility are consumed on-site and not taken outside of the facility, which is a requirement for compliance with sales licenses for on-premise consumption of alcohol.

There exists a need for an effective, automatic beverage can opener that can be used in a vending machine to reliably and repeatedly open the tab of a can before delivery to an individual.

### SUMMARY

The present disclosure provides an automatic beverage can opener and methods automated methods for providing an open beverage can, and in particular to an automatic beverage can opener for use in a vending or other dispensing machine.

In an embodiment, the present disclosure relates to an automatic beverage can opener comprising: a lever, the lever being automated and movable about a lever pivot axis; a wedge mechanism that is rotatably interconnected to the lever, the wedge mechanism comprising a tab engagement finger; and a can holder and/or rotation module for positioning a beverage can in a position where a tab thereof can be engaged by the tab engagement finger upon automated movement of the lever.

In an embodiment, the lever pivot axis is at or near a first end of the lever.

In an embodiment, in operation, as a second end of the lever distal to the lever pivot axis is moved downward towards the beverage can, the tab engagement finger contacts a top of the beverage can and by rotational movement of the wedge mechanism the tab engagement finger is positioned between the top of the beverage can and the tab.

In an embodiment, in operation, as the lever is moved upward at the second end away from the beverage can, the tab engagement finger opens the tab of the beverage can.

In an embodiment, the automatic beverage can opener herein further comprises a locker for locking the tab engagement finger in a locked configuration when the tab engagement finger is positioned between the top of the beverage can and the tab. In an embodiment, the locker is pivotedly connected to the lever at a locker pivot axis, wherein the lever pivot axis and the locker pivot axis are proximate each other on the lever. In an embodiment, in operation, prior to contact with the top of the beverage can, the tab engagement finger is oriented in a downward pointing direction and a lock prevention edge on an opposite end of the wedge mechanism prevents locking of the locker. In an embodiment, in operation, rotational movement of the wedge mechanism upon contact with the top of the beverage can moves the lock prevention edge out from under the locker to allow the locker to pivot about the locker pivot axis and put the tab engagement finger in the locked configuration. In an embodiment, when the tab engagement finger is in the locked configuration, the locker prevents further rotational movement of the tab engagement finger. In an embodiment, the locker prevents further rotational movement of the tab engagement finger by an end of the locker distal to the locker pivot axis abutting against an underside portion of the wedge mechanism.

In an embodiment, the automatic beverage can opener herein further comprises an unlocker for unlocking the tab engagement finger from the locked configuration. In an embodiment, the unlocker is pivotedly connected to the lever at an unlocker pivot axis and is configured to unlock the locker upon pivotal rotation about the unlocker pivot axis. In an embodiment, a first portion of the unlocker is positioned under the locker. In an embodiment, in operation, after the tab has been opened and the lever moves upward, a second portion of the unlocker contacts a stopper causing rotation of the unlocker about the unlocker pivot axis to push the first portion of the unlocker upwards to unlock the locker.

In an embodiment, the automatic beverage can opener herein further comprises a stand apparatus operably connected to the lever at the lever pivot axis and at the opposite end of the lever to provide automated movement of the lever. In an embodiment, the stand apparatus comprises a threaded rod and a threaded platform, wherein the lever is operably connected to the threaded platform distal to the lever pivot axis. In an embodiment, the can holder and/or the rotation module are operably interconnected to the stand at a position below the lever.

In an embodiment of the automatic beverage can opener herein, the can holder and/or rotation module are configured for holding variety of different beverage can sizes. In an embodiment, the can holder comprises a flat platform on which the beverage can sits, and the flat platform comprises two or more prongs, each prong being retractable and extendable relative to a center position on the flat platform for engaging the beverage can. In an embodiment, in operation, the can holder or a component thereof rotates the beverage can to align the tab with the tab engagement finger.

In an embodiment, in operation, the can holder lifts the can to position it within the rotation module of the automatic beverage can opener.

In an embodiment of the automatic beverage can opener herein, the rotation module comprises a jaw chuck and a chuck gear. In an embodiment, in operation, rotation of the chuck gear in a first phase engages the jaws of the jaw chuck against the beverage can and in a second phase rotates the beverage can.

In an embodiment, the automatic beverage can opener herein further comprises one or more sensors for automated operation. In an embodiment, the one or more sensors are for positioning the beverage can at an opening height and/or detecting the orientation or alignment of the tab with the tab engagement finger.

In an embodiment, the automatic beverage can opener herein comprises a limit switch sensor for positioning the beverage can at an opening height. In an embodiment, the limit switch sensor indexes the position of a top rim of the beverage can for automated positioning of the beverage can at the opening height.

In an embodiment, the automatic beverage can opener herein comprises a laser sensor or an optical sensor for detecting the orientation or alignment of the tab with the tab engagement finger.

In an embodiment of the automatic beverage can opener and methods herein, during automated movement of the lever to open the tab, the beverage can remains stationary. In an embodiment, the speed of movement of the lever is adjustable to adjust the time of an opening procedure.

In an embodiment, the automatic beverage can opener and methods herein automatically open the beverage can without human interaction.

In an embodiment, the automatic beverage can opener herein automatically detects placement of the beverage can on the can holder and/or within the rotation module, height position of the beverage can, location of the tab on the top of the beverage can, orientation or alignment of the tab with the tab engagement finger, locking of the tab engagement finger underneath the tab, unlocking of the tab engagement finger, upper travel limit of the lever being reached, or any combination thereof.

In an embodiment, the automatic beverage can opener herein is capable of automatically disengaging the beverage can and resetting to a start position in the same movement as the opening of the tab of the beverage can.

In an embodiment, the automatic beverage can opener herein is capable of discarding beverage cans with issues.

In an embodiment, the automatic beverage can opener herein further comprises one or more side wall supports for surrounding at least a portion of the beverage can.

In an embodiment, the present disclosure relates to a method for automatically opening a beverage can, the method comprising employing the automatic beverage can opener as disclosed herein.

In an embodiment, the present disclosure relates to a method for automatically opening a beverage can, the method comprising: automated delivery of a beverage can to a can holder and/or a rotation module upon an activation signal; automated detection of a tab on the top of the beverage can and alignment of the tab with a tab engagement finger of an automatic beverage can opener; automated engagement of the tab engagement finger with the beverage can by activation and downward movement of a lever of the automatic beverage can opener, whereby upon contact with the beverage can the tab engagement finger rotates about a wedge rotation axis on the lever to position the tab engagement finger between the top of the beverage can and the tab; automated locking of the tab engagement finger to prevent further rotational movement; and automated upward movement of the lever to open the tab on the beverage can.

In an embodiment, the present disclosure relates to a kit-of-parts for assembling the automatic beverage can opener as disclosed herein, the kit-of-parts comprising: a lever, a wedge mechanism having a tab engagement finger, and a can holder. In an embodiment, the kit-of-parts further comprises a locker. In an embodiment, the kit-of-parts further comprises a stand apparatus. In an embodiment, the kit-of-parts further comprises an unlocker. In an embodiment, the kit-of-parts further comprises a rotation module.

In an embodiment, the present disclosure relates to a vending machine comprising the automatic beverage can opener as disclosed herein.

Other aspects and embodiments of the disclosure are evident in view of the detailed description provided herein.

### BRIEF DESCRIPTION OF THE DRAWINGS

These and other features of the present disclosure will become more apparent in the following detailed description in which reference is made to the appended drawing. The appended drawing illustrates one or more embodiments of the present disclosure by way of example only and is not to be construed as limiting the scope of the present disclosure.

FIG. 1 is a dissected view of an exemplary automatic beverage can opener of the present disclosure.

FIG. 2 is a perspective view of an exemplary automatic beverage can opener of the present disclosure where the beverage can is not yet positioned within the stand.

FIG. 3 is a side view of an exemplary automatic beverage can opener of the present disclosure where the beverage can is not yet positioned within the stand.

FIG. 4 shows an exemplary automatic beverage can opener of the present disclosure before the tab of the beverage can is aligned with the tab engagement finger.

FIG. 5 shows an expanded view of the indicated and encircled features in FIG. 4.

FIG. 6 is a side view of an exemplary automatic beverage can opener of the present disclosure where the tab of the beverage can is aligned with the tab engagement finger.

FIG. 7 shows an expanded view of the indicated and encircled features in FIG. 6.

FIG. 8 is an elevated perspective view of an exemplary automatic beverage can opener of the present disclosure where the tab of the beverage can is aligned with the tab engagement finger.

FIG. 9 shows an expanded view of the indicated and encircled features in FIG. 8.

FIG. 10 is a side view of an exemplary automatic beverage can opener of the present disclosure where the lever is being moved downward toward the beverage can to engage the tab engagement finger of the wedge mechanism with the tab of the beverage can.

FIG. 11 shows an expanded view of the indicated and encircled features in FIG. 10.

FIG. 12 is a perspective view of an exemplary automatic beverage can opener of the present disclosure where, by rotational motion, the tab engagement finger of the wedge mechanism is positioned under the tab of the beverage can, and the locker has engaged to lock the tab engagement finger in place.

FIG. 13 shows an expanded view of the indicated and encircled features in FIG. 12.

FIG. 14 is a side view of an exemplary automatic beverage can opener of the present disclosure where the lever is being moved upward away from the top of the beverage can to lift the tab and open the beverage can.

FIG. 15 shows an expanded view of the indicated and encircled features in FIG. 14.

FIG. 16 is a side view of an exemplary automatic beverage can opener of the present disclosure where the lever continues to move upward away from the top of the beverage can until an unlocker contacts a stopper.

FIG. 17 shows an expanded view of the indicated and encircled features in FIG. 16.

FIG. 18 is a side view of an exemplary automatic beverage can opener of the present disclosure where upon contacting the stopper, the unlocker disengages the locker, thereby restoring the wedge mechanism to its original position, whereby the automatic beverage can opener is armed for the next beverage can.

FIG. 19 shows an expanded view of the indicated and encircled features in FIG. 18.

FIG. 20 is a perspective view of another exemplary automatic beverage can opener of the present disclosure where the beverage can is not yet positioned within the stand.

FIG. 21 is a perspective view (below, looking up) of exemplary features within the rotation module and can opener module of the automatic beverage can opener of FIG. 20.

FIG. 22 is a perspective view (above, looking down) of exemplary features within the rotation module and can opener module of the automatic beverage can opener of FIG. 20.

FIG. 23 is an expanded view of exemplary features within the can opener module of the automatic beverage can opener of FIG. 20.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the exemplary suitable methods and materials are described below.

The present disclosure provides an automatic beverage can opener and automated methods for opening a beverage can, and in particular to an automatic beverage can opener for use in a vending or other dispensing machine.

The automatic beverage can opener of the present disclosure is capable of achieving a number of objectives, including without limitation: opening a can without human interaction; minimizing can shaking during opening; minimizing liquid spillage; minimize drink contamination; and providing ease of cleaning and maintenance of the operating mechanism.

The automatic beverage can opener of the present disclosure is capable of providing a number of advantages, including without limitation: being automatically operated without need of human interaction; providing consistent and reliable opening of the beverage can; capable of variable opening times during the opening procedure; avoids the need to have the can move during the opening procedure, which increases risks of spillage; employs a smooth opening process; and ease of maintenance.

In some embodiments, the beverage can is immobilized during the opening procedure. This can be advantageous in minimizing spillage.

In some embodiments, the opening procedure employs a constant opening time, that can be tuned, and is controllably repeatable. The automatic beverage can opener of the present disclosure provides a smooth opening process.

In some embodiments, the automatic beverage can opener employs one or more sensors, for example to accurately position the beverage can at an opening height, to align the tab of the beverage can with the tab engagement finger of the opener disclosed herein, to limit upward movement of the lever of the opener disclosed herein, and/or to monitor and control any step in the opening process. Advantageously, this also allows to consistently orient the beverage can in the same orientation when delivered to an individual from a vending machine.

The present disclosure provides an advantageous automatic beverage can opener comprising improved design and features, and advantageous methods for automated opening of a beverage can.

In an embodiment, the present disclosure relates to an automatic beverage can opener comprising: a lever, the lever being automated and movable about a lever pivot axis; a wedge mechanism that is rotatably interconnected to the lever, the wedge mechanism comprising a tab engagement finger; and a can holder and/or rotation module for positioning a beverage can in a position where a tab thereof can be engaged by the tab engagement finger upon automated movement of the lever.

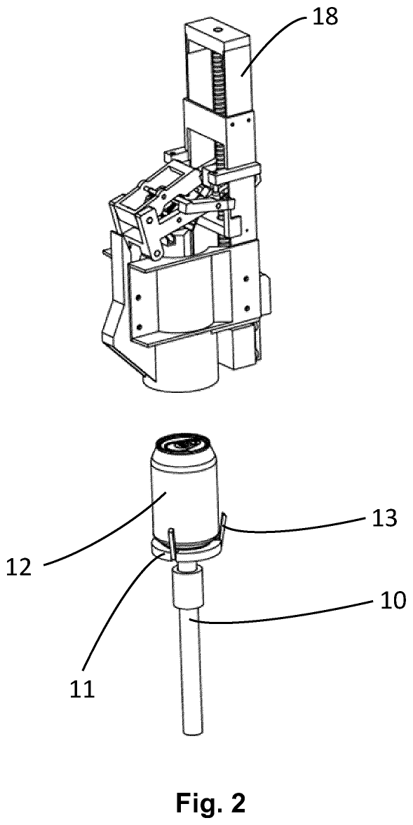

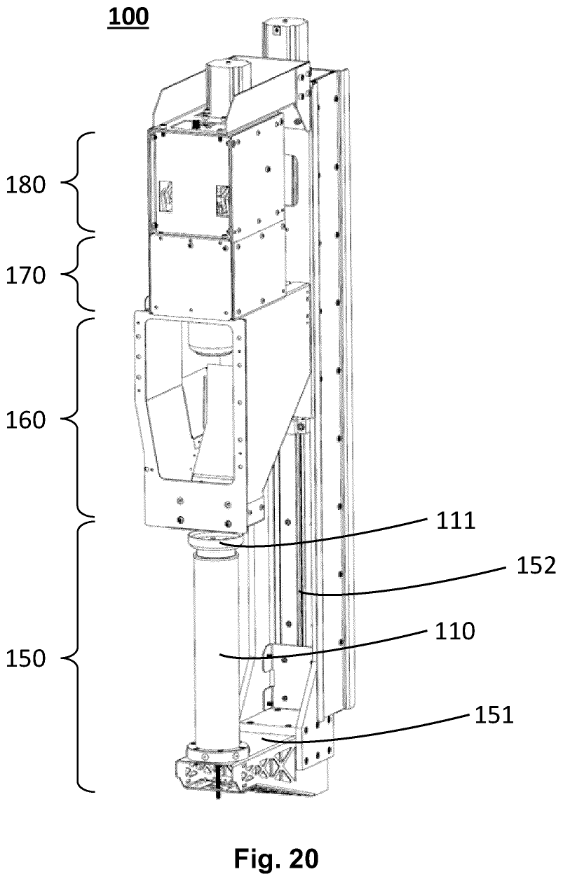

As used herein, by “automatic beverage can opener” it is meant an apparatus, system or device for the automatic opening of a beverage can. In some embodiments, the automatic beverage can opener may be a single apparatus with all components interconnected in some manner. In other embodiments, the automatic beverage can opener may be a system of interrelated components in which not all of the components have a physical connection to other components of the system. For example, in some embodiments the can holder may have no interconnection with other components of the automatic beverage can opener (see e.g. FIG. 2). However, in other embodiments, the can opener is interconnected with the other components of the beverage can opener (see e.g. FIG. 20).

The lever of the beverage can opener herein can take many different configurations and shapes. As used herein, “lever” is intended to encompass any structure that can be subjected to rotation about a pivot axis and can interconnect to a wedge mechanism in a manner that the wedge mechanism can rotate on the lever. In an embodiment, the lever is configured in a manner that the axis of rotation of the lever (lever pivot axis) and axis of rotation of the wedge mechanism (wedge pivot axis) are parallel. In an embodiment, the lever is configured in a manner that the lever pivot axis and the wedge pivot axis are distal to each other on the lever. In an embodiment, the lever pivot axis is at one end of the lever and the wedge pivot axis distal to that end, typically being at least past the midpoint of the length of the lever away from the lever pivot axis.

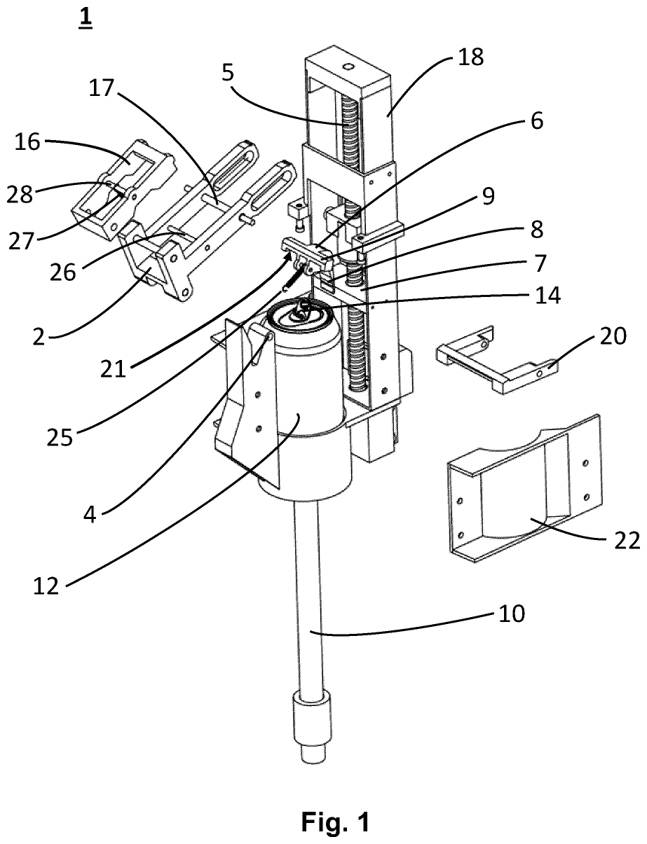

In an embodiment, the lever is shaped similar to a “T”. For example, the lever may be comprised of two “T” shaped pieces of material (e.g. metal) that are oriented front-to-back to each other. The two “T” shaped members may be separate pieces held together by any suitable means (e.g. by one or more rods) and/or the “T” shaped members may be a single unit formed of one piece of metal connected together front-to-back (see e.g. FIG. 1). The “T” shaped members may be a particularly suitable shape since the lever pivot axis and locker pivot axis can be positioned at opposite sides across the top of the “T” and the wedge pivot axis can be positioned somewhere along the “I” portion of the “T”. The front-to-back “T” shape configuration also provide a suitable space for the wedge mechanism to be suspended from a bar or rod at the point of the wedge pivot axis (see 17 in FIG. 1). As the skilled person will appreciate, this shape is merely exemplary and many other shapes and configurations for the lever are possible and contemplated herein. In an embodiment, the lever is made of metal or a metal alloy, but other materials having a sufficient hardness and strength may also be used.

The wedge mechanism of the automatic beverage can opener herein can likewise take many different configurations and shapes. As used herein, “wedge mechanism” is intended to encompass any structure that is capable of being rotated about a pivot axis on the lever (e.g. on a bar or rod) and has a feature or surface that can fit between the tab and the top of a beverage can, referred to herein as the tab engagement finger. Thus, at least some part of the wedge mechanism would typically be of a thin elongate shape. In some embodiments, this thin elongate shape is curved along its length and gets narrower in width as it approaches the end distal to the axis of rotation. In some embodiments, the thin elongate shape is also thinnest at the end distal to the axis of rotation and increases in thickness gradually moving away from this end (see 8 in FIG. 1). As the skilled person will appreciate, this shape is merely exemplary and many other shapes and configurations for the lever are possible and contemplated herein. In an embodiment, the wedge mechanism is made of metal or a metal alloy, but other materials having a sufficient hardness and strength may also be used.

In some embodiments herein, the wedge mechanism comprises a lock prevention edge. As used herein, by “lock prevention edge” it is meant any feature or structure of the wedge mechanism that is capable of reversibly preventing the locker from moving into its locked configuration. In some embodiments herein, the lock prevention edge is configured to allow the locker to lock by being rotated out of its preventative state when the wedge mechanism rotates to engage underneath the tab of a beverage can. This is a convenient configuration since rotation of the wedge mechanism simultaneous achieves two functions: (1) engages under the tab, and (2) unlocks the locker. In an embodiment, the lock prevention edge is a wider portion of the wedge mechanism (e.g. a bar) that is positioned at an end of the wedge mechanism opposite the tab engagement finger (see 9 in FIG. 1). In an embodiment, the lock prevention edge is positioned underneath an end of the locker distal to the locker pivot axis. Thus, when the wedge mechanism rotates, it rotates the lock prevention edge out from under the end of the locker and allows the locker to pivot downwards to lock the wedge mechanism in place (i.e. preventing further rotation of the lock mechanism). In an embodiment, the lock prevention edge has a curved outer facing surface for ease of rotation against the underside of the locker.

As shown in FIG. 1, one configuration for allowing the wedge mechanism to rotate on the lever is for the lever to have a pivot bar onto which the wedge mechanism is suspended and rotates about. In an embodiment, the wedge mechanism is able to freely rotate. In other embodiments, the wedge mechanism is biased to a particularly orientation or position. In a particular embodiment, the wedge mechanism is biased to an original position. As used herein, “original position” is intended to mean a position where the tab engagement finger is armed and ready to engage a beverage can. In this original position, the tab engagement finger is in a downwardly pointing state so the end of the tab engagement finger is ready to contact the top of the beverage can and then rotate under the tab. In an embodiment, the wedge mechanism is biased to this original state by a spring (i.e. a wedge spring). The spring connects to another component, such as the lever, to appropriately bias the tab engagement finger to the original position. As will be appreciated, other biasing features may be used, for example counter-balancing.

The automatic beverage can opener of the present disclosure is capable of determining the location of the tab on the top of the beverage can and aligning the tab with the tab engagement finger. In an embodiment, the can holder is configured to rotate the beverage can. For example, in an embodiment, upon determination of the location of the tab on the top of the beverage can, a flat platform of the can holder (on which the can sits) may be rotated. In some embodiments, to ensure the beverage can does not move during operation, the flat platform of the can holder may have features that engage the beverage can and hold it in place. Any suitable features or structures may by used. In an embodiment, the flat platform has sidewalls that are either capable of movement or have an inner surface that is compressible into which the can is place. In another embodiment, the flat platform comprises upwardly extending prongs that are capable of being retracted and extended to engage and disengage the beverage can.

As discussed earlier herein, the can holder may or may not be interconnected to other components of the automatic beverage can opener. In an embodiment, the can holder functions to move the beverage can in an upward and downward motion. In this regard, in some embodiments, the term “can holder” is intended to encompass a lift or lift apparatus, and function in this regard. Thus, in some embodiments “can holder” may be used to refer to a lift or lift apparatus. In an embodiment, the can opener comprises a flat platform for holding thereon the beverage can and a lift apparatus for moving the can upwards and/or downwards. As the skilled person will appreciate, the can opener can be a free-standing and separate component. While it does not need to be connected to other components of the beverage can opener, it must be appropriately configured to deliver a beverage can to other components. For example, positioning the beverage can for engagement by the tab engagement finger and/or delivering the beverage can to a rotation module as described herein.

The automatic beverage can opener of the present disclosure may or may not include a rotation module. In embodiments where the can holder functions to rotate the beverage can, the rotation module may be omitted. However, in some embodiments, it may be desirable for the can opener not to operate as a rotation mechanism. In such embodiments, in the automatic beverage can opener of the present disclosure the beverage can may be delivered to the rotation module either by the can opener or by other means. For example, in some embodiments, a vending machine may drop or feed the beverage can directly into a rotation module of the present disclosure, and a consumer may obtain the beverage from an opening in the vending machine that opens to the rotation module. However, it is likely preferable that consumers not be accessing the beverage can from the same compartment as the rotation module, such that a can holder or lift would still be used to move the beverage can in and out of a funnel module where a consumer can access the beverage without exposure to functional components the opening system.

As used herein, the term “rotation module” is meant to refer to a localized collection of components (e.g. within a compartment) that function to rotate the beverage can to properly align the tab of the beverage can with the tab engagement finger. Many different configurations of components may be used.

In an embodiment, the rotation module comprises a jaw chuck. In such embodiments, the beverage can may be delivered through the bore in the jaw chuck (e.g. by the can holder or other lift mechanism) to position the beverage can between the jaws of the jaw chuck. The jaws of the jaw chuck may be configured to move inwards and outwards in any suitable manner, many of which are known in the art. In an embodiment, the jaws may be uniformly moved by the turning of one or more screw mechanisms that function to move each jaw inward or outward depending on the direction of turning. In another and more advantageous embodiment disclosed herein, a gear (chuck gear) may be positioned on top of the jaws. A pin extending upward from each jaw may be positioned within individual grooves in the chuck gear. Rotation of the chuck gear will move the pin through the groove. Movement of the pin in one direction along the groove will cause the jaws to retract simultaneously, while movement in the other direction within the groove will cause the jaws to extend simultaneously. The chuck gear may be rotationally driven by a motor either directly or via other interconnecting gears.

In am embodiment, when the beverage can is delivered to the jaw chuck, activation of a motor functions to turn the chuck gear in an appropriate direction to cause the jaw to engage the can. Advantageously, it has be found herein that after this initial phase of engaging the jaws against the beverage can, the chuck gear can be rotated further in the same direction to turn the jaw chuck and thereby turn the beverage can within the jaw chuck. This is quite advantageous since a single mechanism can both engage the beverage can and rotate the can to align the tab with the tab engagement finger. Then, when it is desired to release the beverage can, the chuck gear need only be turned in the opposite direction to disengage the jaws from the side of the beverage can. Any suitable jaw chuck may be used. In an embodiment, it is a 3-jaw chuck, 4-jaw chuck, 5-jaw chuck or 6-jaw chuck.

In the automatic beverage can opener herein, one or more sensors may be used to achieve accurate automated operation. The sensor may be of any suitable type. In an embodiment, the sensors are limit switch sensors, laser-equipped sensors (laser sensors), imaging sensors, or optical sensors.

In an embodiment, a limit switch sensor is used to accurately position the beverage can at an opening height. For example, as the beverage can is moved up towards the tab engagement finger, an arm of a limit switch sensor may be configured to contact the top of the beverage can. In a particular embodiment, the arm of the limit switch sensor indexes the upper rim of the beverage can. The rim of the beverage can has been found to be an ideal indexing feature for subsequent accurate identification of the tab of the beverage can.

In an embodiment, a laser sensor is used to accurately identify the tab on the top of the beverage can, and align the tab with the tab engagement finger. In an embodiment, after the beverage can is positioned at opening height, the can is rotated while a laser sensor is directed to the top of the can. Differences in distance of travel of the laser are used to pinpoint the location of the tab and automate proper alignment of the tab with the tab engagement finger.

Once the tab is aligned with the tab engagement finger, rotation of the can stops and automated lowering of the lever occurs to position the tab engagement finger under the tab, with concurrent locking of the wedge mechanism in a locked configuration that prevents rotation. This then signals automated upward movement of the lever to lift the tab and open the beverage can.

Locking of the wedge mechanism is described elsewhere herein. Notably, the locker may be of any suitable shape to prevent rotation of the wedge mechanism. There are many different ways and configurations by which this could be achieved. In an embodiment, an effective configuration herein is to have a rectangular shaped locker that pivots about a locker pivot axis at the same end of the lever as the lever pivot axis. When the wedge mechanism rotates to move the lock prevention edge out from underneath the locker, the rectangular shaped locker drops down unto the “I” portion of the “T” shaped lever to put the end of the locker distal to the locker pivot axis up against an underside portion of the wedge mechanism. In an embodiment, the underside portion is the underside of the lock prevention edge. Thus, in minimalist efficiency, the bar structure that was at one time preventing the locker from engaging into a locking position is now the surface against which the locker abuts to prevent rotation of the wedge mechanism.

After the beverage can is opened, the tab engagement finger is restored to its original position whereby it is armed and ready to engage and open the next beverage can. In an embodiment, this may be accomplished by an unlocker that unlocks the locker and restores the rotational ability of the wedge mechanism. The unlocker may be of any suitable shape to disengage the locker. There are many different ways and configurations by which this could be achieved.

In an embodiment, an effective configuration herein is to employ another component capable of pivoting about a pivot axis on the lever. In an embodiment, the unlocker pivots about the same bar or rod that is used to suspend the wedge mechanism. Thus, in minimalist efficiency again, another component of the automatic beverage can opener herein serves multiple purposes. For the unlocker, an appropriate configuration may be selected such that a portion of the unlocker is positioned under the locker and another portion of the unlocker, on the other side of the unlocker pivot axis, is capable of contacting a structure that will cause the unlocker to pivot and force upwards the locker, thereby allowing the wedge mechanism to rotate back to its original position (e.g. by biasing already described) and place the lock prevention edge under the locker again. In an embodiment, the suitable shape of the unlocker may be a “U” shape structure (see 20 in FIG. 1), where the arms of the “U” contact a stopper feature on upward movement of the lever, and contact with the stopper forces the unlocker to rotate about the unlocker pivot axis and force upwards the locker.

In an embodiment, the automatic beverage can opener herein further comprises a stand apparatus. The stand apparatus may provide structural support and configuration to the other components described herein and/or may provide a function in the automated operation of the automatic beverage can opener herein. For example, in an embodiment the stand apparatus houses the one or more sensors and any computer processing equipment needed for automated operation.

In an embodiment, the stand apparatus is configured to hold and operate the lever. For example, in an embodiment the stand apparatus is operably connected to the lever at or near the lever pivot axis and also at the opposite end of the lever to provide automated movement of the lever. Movement of the lever may be by any suitable mechanism and/or structure, for example on a track, a threaded mechanism, a slide-and-rail structure, a piston, or the like. In an embodiment, the stand apparatus comprises a threaded rod and a threaded platform, wherein the lever is operably connected to the threaded platform at a surface or structure distal to the lever pivot axis.

The stand apparatus may also comprise functional components for movement of the cup holder or other suitable lift system. Movement of the cup holder or other suitable lift system may be by any suitable mechanism and/or structure, for example on a track, a threaded mechanism, a slide-and-rail structure, a piston, or the like. In an embodiment, the can holder and/or the rotation module are operably interconnected to the stand at a position below the lever.

The stand apparatus may also comprise functional components for the rotation module. For example, in an embodiment, the motor used to drive the chuck gear or other suitable rotation mechanism within the rotation module is positioned in the stand.

In an embodiment, the stand apparatus may comprise one or more side wall supports for surrounding at least a portion of the beverage can. The side walls may provide support to the upright stranding of the beverage can and/or one or more of the sidewalls could be moveable (e.g. to engage the can to perform a rotation function or to open and expose the beverage can to a consumer to obtain the opened beverage can.

In an embodiment of the automatic beverage can opener herein, the can holder and/or rotation module are configured for holding variety of different beverage can sizes. In an embodiment, the can holder and/or rotation module are configured for holding a can ranging in liquid volume size from 50 mL to 1000 mL, more particularly 250 mL to 750 mL, and more particularly still 355 mL to 750 mL. In a particular embodiment, the can holder and/or rotation module are configured for holding a 355 mL beverage can (e.g. a 12 oz beer can). In a particular embodiment, the can holder and/or rotation module are configured for holding a 473 mL beverage can (e.g. a 16 oz beer can). In a particular embodiment, the can holder and/or rotation module are configured for holding a 740 mL beverage can (e.g. a 25 oz beer can).

In an embodiment, the automatic beverage can opener herein automatically detects placement of the beverage can on the can holder and/or within the rotation module. This may be, for example and without limitation, by laser, optical or weight sensor.

In an embodiment, the automatic beverage can opener herein automatically detects the height position of the beverage can. This may be, for example and without limitation, by a limit switch, laser, or optical sensor.

In an embodiment, the automatic beverage can opener herein automatically detects location of the tab on the top of the beverage can. This may be, for example and without limitation, by a laser, imaging, or optical sensor.

In an embodiment, the automatic beverage can opener herein automatically detects orientation or alignment of the tab with the tab engagement finger. This may be, for example and without limitation, by a laser, imaging, or optical sensor.

In an embodiment, the automatic beverage can opener herein automatically detects locking of the tab engagement finger underneath the tab. This may be, for example and without limitation, by a limit switch, laser, imaging, or optical sensor.

In an embodiment, the automatic beverage can opener herein automatically detects unlocking of the tab engagement finger. This may be, for example and without limitation, by a limit switch, laser, imaging, or optical sensor.

In an embodiment, the automatic beverage can opener herein is capable of discarding beverage cans with issues. This may be accomplished by sensors. In an embodiment, this may be by a weight sensor, an optical sensor, or an imaging sensor.

In an embodiment, the automatic beverage can opener herein automatically detects upper travel limit of the lever being reached, or any combination thereof. This may be, for example and without limitation, by a limit switch, laser, imaging, or optical sensor.

In an embodiment, the automatic beverage can opener herein is capable of automatically disengaging the beverage can and resetting to a start position in the same movement as the opening of the tab of the beverage can. This may be accomplished as described herein by upward movement of the lever to thereby disengage the beverage can and trigger an unlocker to reset the wedge mechanism to an original position.

Reference will now be made in detail to exemplary embodiments of the present disclosure, wherein numerals refer to like components, examples of which are illustrated in the accompanying drawings that further show exemplary embodiments of the present disclosure, without limitation.

FIG. 1 is an exemplary automatic beverage can opener 1 of the present disclosure.

In an embodiment, an automatic beverage can opener 1 of the present disclosure comprises a lever 2, the lever 2 being automated and movable about a lever pivot axis 4; a wedge mechanism 6 that is rotatably interconnected to the lever 2, the wedge mechanism 6 comprising a tab engagement finger 8; and a can holder 10 for positioning a beverage can 12 in a position where a tab 14 thereof can be engaged by the tab engagement finger 8 upon automated movement of the lever 2.

In an embodiment, the automatic beverage can opener 1 further comprises a locker 16 for locking the tab engagement finger 8 in a locked configuration for opening the tab of the beverage can.

In an embodiment, in operation, as the lever 2 is moved downward towards the beverage can 12, the tab engagement finger 8 contacts a top of the beverage can and by rotational movement is positioned between the top of the beverage can 12 and the tab 14.

In an embodiment of the automatic beverage can opener 1, when the tab engagement finger 8 is positioned between the top of the beverage can 12 and the tab 14, the locker 16 prevents further rotational movement of the tab engagement finger 8.

In an embodiment, in operation, as the lever 2 is moved upward away from the beverage can 12, the tab engagement finger 8 opens the tab 14 of the beverage can 12.

In an embodiment of the automatic beverage can opener 1, the can holder 10 is configured for holding variety of different can sizes. The can holder 10 may further serve as a lift to position the beverage can within a stand 18 of the beverage can opener, for example positioning the can within side wall supports 22.

In an embodiment, the automatic beverage can opener 1 further comprises a sensor for detecting the orientation or alignment of the tab 14 with the tab engagement finger 8. In an embodiment, the sensor is an optical sensor.

In an embodiment, in operation, the can holder 10 or another component is capable of rotating the beverage can 12 to align the tab 14 with the tab engagement finger 8.

In an embodiment, the automatic beverage can opener 1 further comprises a validation check means for confirming that the tab 14 of the beverage can 12 has been opened.

In an embodiment, in operation, during automated movement of the lever 2 to open the tab 14, the beverage can 12 remains stationary.

In an embodiment, the automatic beverage can opener 1 further comprises a cleaning apparatus to clean the tab engagement finger 8 after each completed operation of opening the tab 14.

In an embodiment, in operation, the speed of movement of the lever 2 is adjustable to adjust the time of an opening procedure. In an embodiment, the opening procedure is varied depending of the size of the beverage can 12 or the type of liquid in the beverage can 12.

In an embodiment, the automatic beverage can opener 1 automatically opens a beverage can 12 without human interaction.

In an embodiment, the automatic beverage can opener 1 automatically detects the orientation of the tab 14.

In an embodiment, the automatic beverage can opener 1 automatically positions the beverage can 12 for the opening procedure.

In an embodiment, the automatic beverage can opener 1 locks the beverage can 12 in a vertical position for ease of opening.

In an embodiment, in operation, the tab engagement finger 8 is moved around two offset curvatures, an outer one to engage the tab and an inner to pull the tab.

In an embodiment, the automatic beverage can opener 1 is capable of automatically disengaging the beverage can 12 and resetting to a start position in the same movement as the opening of the tab 14 of the beverage can 12.

In an embodiment, the automatic beverage can opener 1 is capable of discarding beverage cans 12 with issues.

In an embodiment, the automatic beverage can opener 1 further comprises a stand apparatus 18. The stand apparatus may support the other components and/or be used to position the automatic beverage can opener 1 within a vending machine.

In an embodiment, the automatic beverage can opener 1 further comprises an unlocker 20 for unlocking the tab engagement finger 8 from the locked configuration.

In an embodiment, the automatic beverage can opener 1 further comprises one or more side wall supports 22 for surrounding at least a portion of the beverage can.

In another embodiment, the present disclosure provides a method for automatically opening a beverage can 12, the method comprising employing the automatic beverage can opener 1 of the present disclosure.

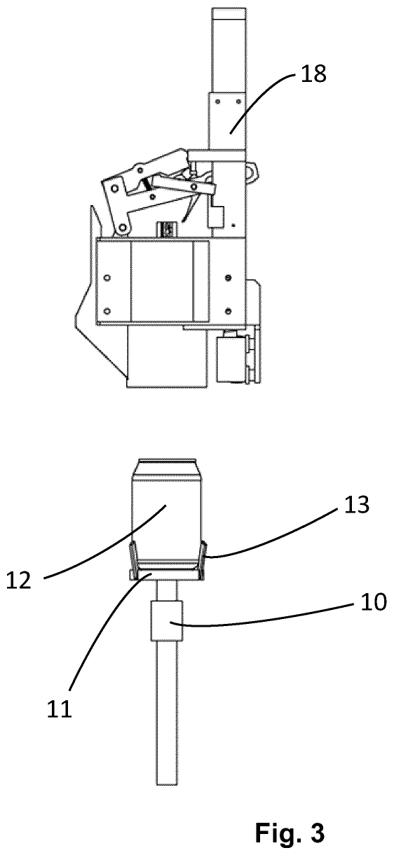

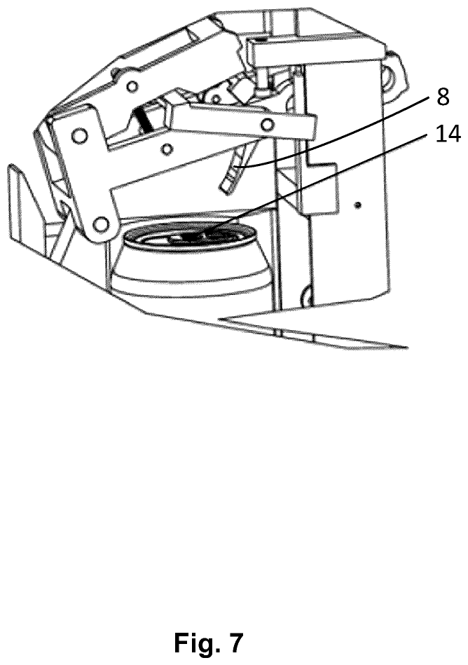

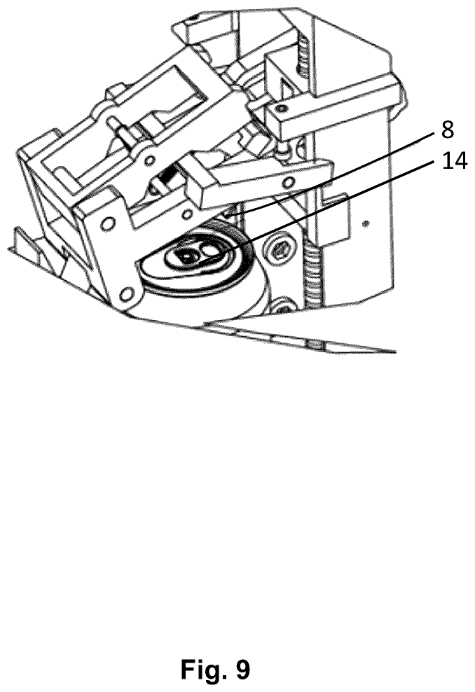

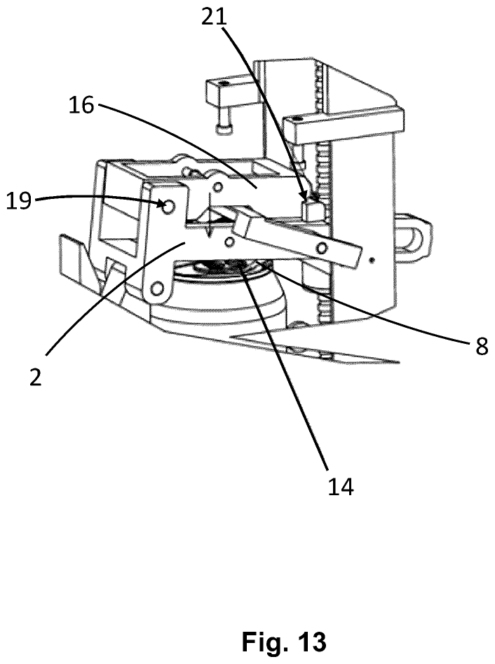

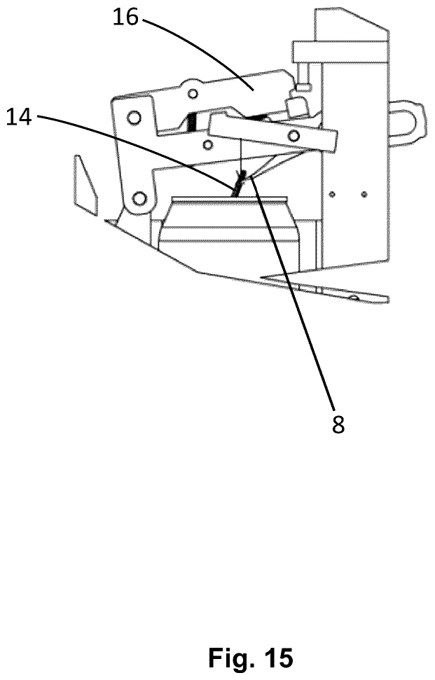

Exemplary operation of an automatic beverage can opener 1 of the present disclosure is shown in FIGS. 2-19. In FIGS. 2 & 3, the beverage can 12 is held by the can holder 10, but is not yet positioned within the stand apparatus 18. Rather, at this stage in the embodiment of FIGS. 2 & 3, the beverage can 12 sits on a flat platform 11 of the can holder 10 and is grabbed or engaged by retractable and extendable prongs 11 that extend upwards from the flat platform 11. The prongs 13 are capable of being extended or retracted inwards and outwards relative to a position, such as a center position, on the flat platform 11 (e.g. inwards and outwards along the radius of the flat platform 11 when it is a circular structure). The engagement of the beverage can 12 by the prongs 13 positions the beverage can 12 at an appropriate position on the flat platform 11 for subsequent engagement by the tab engagement finger 8 of the wedge mechanism 6 (e.g. in the center of the flat platform 11).

Movement of the prongs 13 is an automated operation and may or may not be modulated by sensors. For example, in an embodiment, inward movement begins when it is detected that there is a beverage can 12 on the flat platform 11 and inward movement continues until a pressure threshold is met by engagement of the prongs 13 with the beverage can 12. Other automated mechanisms for controlling and modulating movement of the prongs 13 would be well understood to the skilled person having regard to the present disclosure.

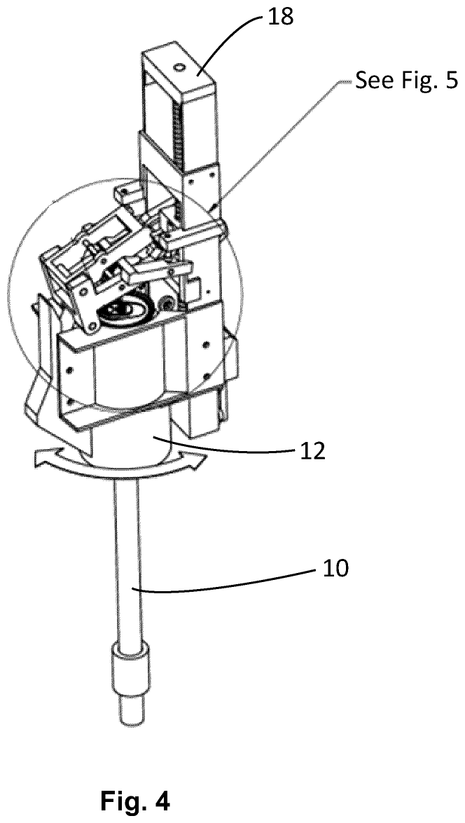

In FIGS. 4 & 5, the beverage can 12 is lifted by the can holder 10 to opening height, but the tab 14 is not yet aligned with the tab engagement finger 8. In other embodiments, the can holder 10 apparatus may not move in a up/down direction, but rather the stand apparatus 18 or components thereof may move downwards to position the beverage can 12 at the opening height. In other embodiments still, both the can holder 10 and the stand apparatus 18 or a component thereof may move to position the beverage can 12 at opening height.

Movement of the can holder 10, the stand apparatus 18 or a component thereof, or both, is an automated operation and may or may not be modulated by sensors. In embodiments where there is movement of both the can holder 10 and the stand apparatus 18 or component thereof to position the beverage can 12 at opening height, the movement of each may be independent and may alternate in timing of operation and/or distance travelled, for example depending on the size of beverage can 12 to be opened. In an embodiment, one or more sensors are used to detect when the beverage can 12 is at its opening height. For example, a sensor may be positioned above the beverage can 12 within or on the stand apparatus 18. In an embodiment, the sensor may be a laser sensor that detects the position of the beverage can 12 to accurately place the beverage can 12 at the opening height. In another embodiment, the sensor may operate by a limit switch such than when movement of the can triggers the limit switch, movement of the beverage can 12 ceases. In an embodiment, the limit switch sensor is configured to engage and/or index with the top rim of the beverage can 12. Other automated mechanisms, types of sensors, positions of sensors, or combinations thereof for controlling and modulating movement of the beverage can 12 to opening height would be well understood to the skilled person having regard to the present disclosure.

As shown in FIG. 4, rotation of the beverage can 12 may occur at the same time as when the beverage can 12 is being moved to the opening height. In an embodiment, such rotational movement is automated and is modulated by sensors capable of detecting the position of the tab 14 on the top of the beverage can 12. For example, a laser sensor oriented with its laser pointing downwards onto the top of the beverage can 12 may detect the tab 14 by differences in distance of travel of the laser to the top of the beverage can 12 versus the top of the tab 14 on the beverage can 12. These differences in distance can allow for automated positioning and alignment of the tab 14 with the tab engagement finger 8 of the wedge mechanism 6. In an embodiment, the laser sensor to locate the tab 14 may be the same or different sensor than that used to position the beverage can 12 at opening height. In an embodiment, a limit switch senor is used to position the beverage can 12 at opening height and a laser sensor is used to detect to position of the tab 14 on the top of the beverage can 12. Other automated mechanisms, types of sensors, positions of sensors, or combinations thereof for identifying to tab 14 and appropriately rotating the beverage can 12 to align the tab 14 with the tab engagement finger 8 would be well understood to the skilled person having regard to the present disclosure.

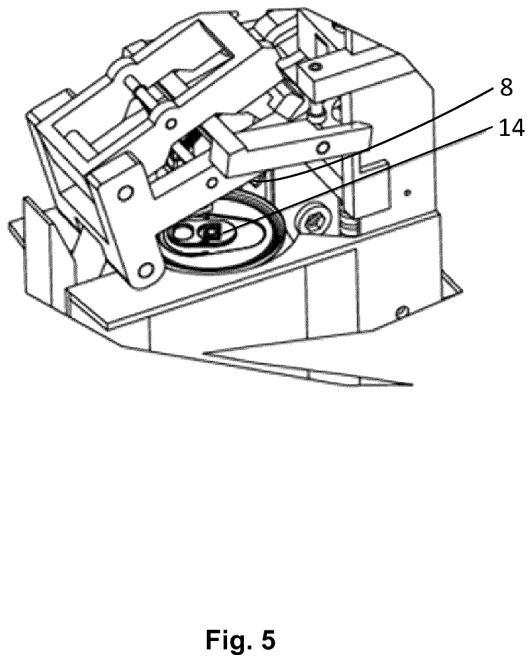

In the embodiment shown in FIG. 5, the tab 14 is not yet aligned with the tab engagement finger 8 of the wedge mechanism 6. As described above, the rotation of the beverage can 12 may occur at the same time as when the beverage can 12 is being moved to the opening height. Thus, in some embodiments, the tab 14 of the beverage can 12 would already be aligned when the opening height is reach. However, in other embodiments, alignment of the tab 14 with the tab engagement finger 8 does not occur until the beverage can 12 is at the opening height. In other embodiments still, some alignment of the tab 14 with the tab engagement finger 8 does begin at the same time as when the beverage can 12 is being moved to the opening height, but fine positioning adjustments are made once the beverage can 12 is at opening height.

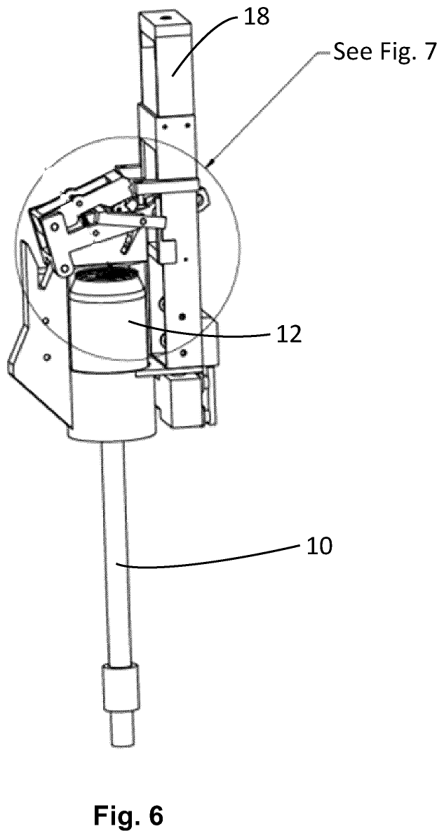

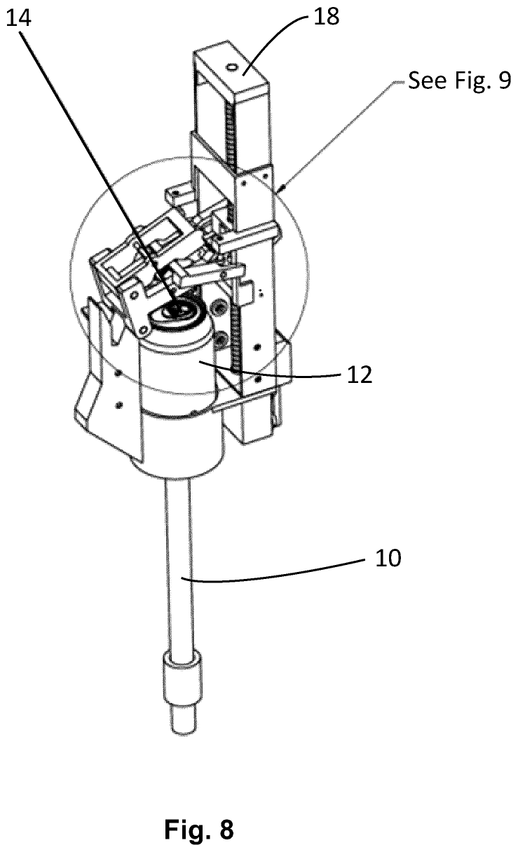

In FIGS. 6 & 7, the beverage can 12 is in the opening position and the tab 14 is now aligned with the tab engagement finger 8 of the wedge mechanism 6. Thus, in this embodiment and as compared to FIG. 5, alignment of the tab 14 of the beverage can 12 with the tab engagement finger 8 has occurred at the opening height. This alignment is an automated process, such as involving one or more sensors as described herein. FIGS. 8 & 9 are similar to FIGS. 6 & 7, but shown at a slightly different viewing angle to better view the top of the beverage can 12.

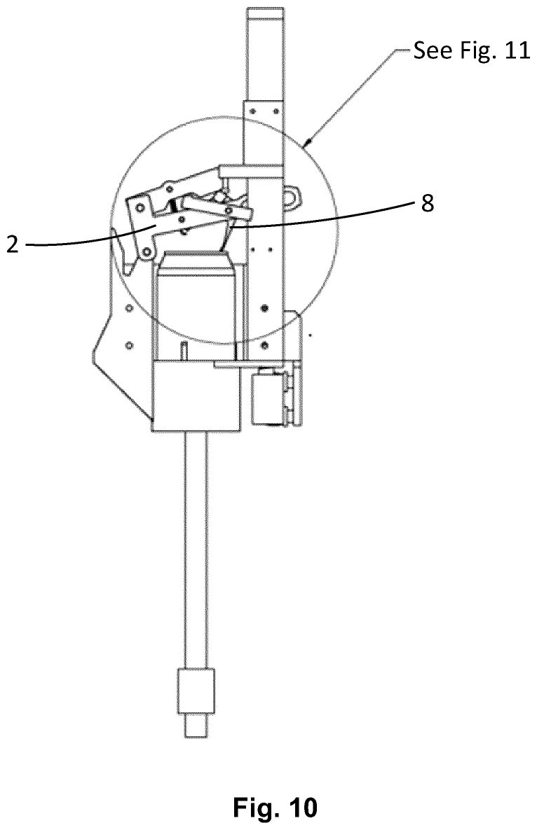

In FIG. 10, the lever 2 of the automatic beverage can opener 1 is being moved downward toward the beverage can 12 to engage the tab engagement finger 8 of the wedge mechanism 6 with the tab 14 of the beverage can 12. Movement of the lever 2 is an automated process. In select embodiments, automated downward movement of the lever 2 commences once one or more sensors of the automatic beverage can opener 1 confirm that the beverage can 12 is at opening height and that the tab 14 has been aligned with the tab engagement finger 8. In some embodiments, there may be some downward movement of the lever prior to these criteria being met, but typically not to an extent that any such downward movement would result in contact between the tab engagement finger 8 and the top of the beverage can 12, unless this movement or contact of the tab engagement finger 8 is involved in positioning of the beverage can 12. For example, in some embodiments, downward movement of the lever 2 and contact between the tab engagement finger 8 and the top of the beverage can 12 may be the signal that the beverage can 12 is at the opening position.

Downward movement of the lever 2 may occur in various different configurations. In the embodiment of FIGS. 1-19, the lever 2 is pivotedly connected to a lever pivot axis 4 on a component of the stand apparatus 18. Rotation of a threaded rod 5 to which the lever 2 is operationally connected causes downward movement of the end of the lever 2 distal to the lever pivot axis 4. This, is turn, causes the tab engagement finger 8 to contact the top of the beverage can 12 and upon further downward movement of the lever 2, position or slide the tab engagement finger 8 underneath the tab 14. In an embodiment, the lever 2 is operationally connected to the threaded rod 5 by fixed attachment, either directly or indirectly, of a portion of the lever 2 distal to the lever pivot axis 4 to a threaded platform 7. In such embodiments, the threaded platform 7 would move up and down on the threaded rod to move the lever 2.

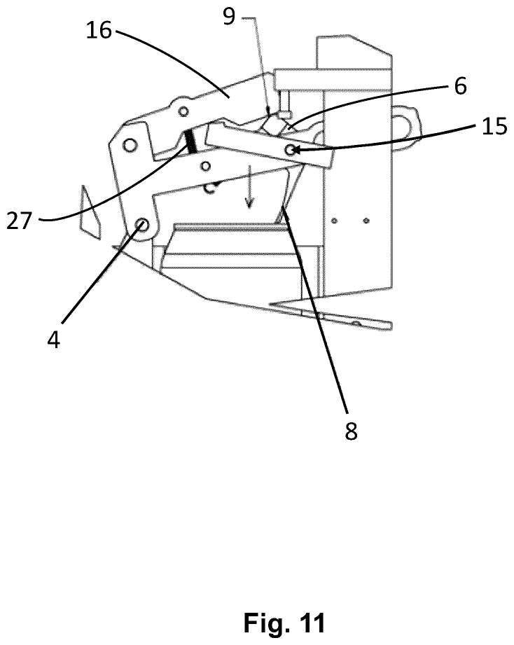

An embodiment of a configuration of various components of the automatic beverage can opener 1 of the present disclosure prior to the tab engagement finger 8 sliding under the tab 14 is shown in FIG. 11. As shown, the tab engagement finger 8 is in contact with the top of the beverage can 12, but the tab engagement finger 8 is still oriented in a downward pointing direction. In this orientation, in the embodiment of FIG. 11, a lock prevention edge 9 of the wedge mechanism 6 maintains the locker 16 in an unlocked configuration. In the unlocked configuration of the locker 16, the wedge mechanism 6 is free to rotate about a wedge pivot axis 15. The wedge pivot axis 15 may be formed by suspending the wedge mechanism 6 from a pivot bar 17 on the lever 2 via a circular bore or hole in the wedge mechanism (not shown).

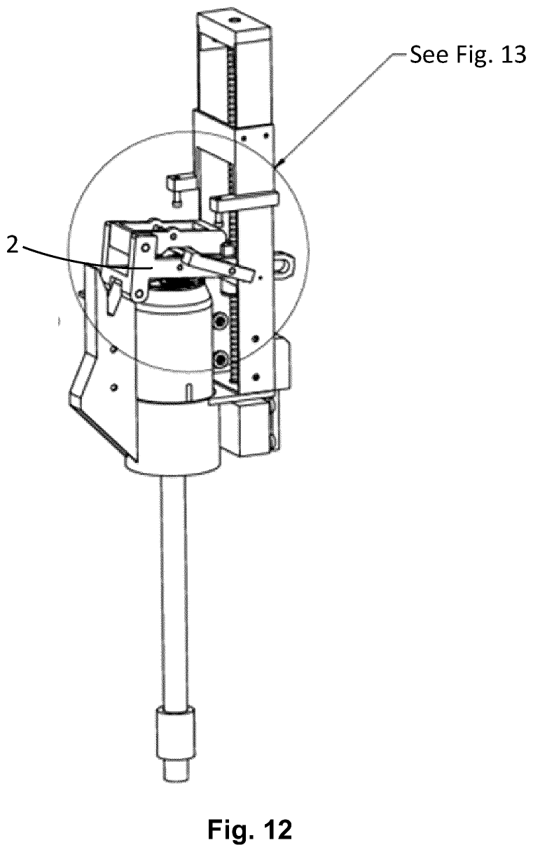

In FIGS. 12 & 13, by further downward motion of the lever 2 and corresponding rotational motion of the wedge mechanism 6, the tab engagement finger 8 of the wedge mechanism 6 slides along the top of the beverage can 12 and is positioned under the tab 14 of the beverage can 12. The rotation of the wedge mechanism 6 moves the lock prevention edge 9 to a configuration that allows the locker 16 to engage and lock the tab engagement finger 8 in place. Comparing FIGS. 11 & 13, in the embodiment shown therein it can be seen that as the wedge mechanism 6 rotates, the lock prevention edge 9 is likewise rotated away from an end of the locker 16 distal a locker pivot axis 19. When the lock prevention edge 9 moves away and is no longer underneath the locker 16, pivotal rotation about the locker pivot axis 19 allows the locker 16 to drop downwards and the end of the locker 16 distal to the locker pivot axis 19 engages against an underside portion 21 of the wedge mechanism 6. As can be seen in FIG. 11, certain embodiments include a locking spring 27 to bias the locker towards the locked position. The locking spring may be connected at one end to a lever spring bar 26 on the lever 2 and at the other end to a locker spring bar 28 on the locker 16.

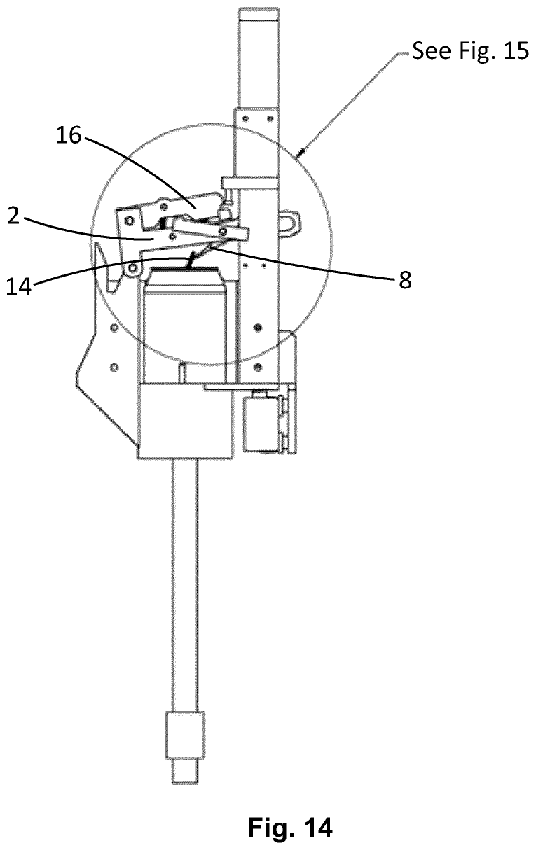

In FIGS. 14 & 15, the lever 2 is moved upward away from the top of the beverage can 12 to lift the tab 14 and open the beverage can 12. Movement of the lever 2 is an automated process. In select embodiments, automated upward movement of the lever 2 commences once locker 16 is locked in position to fix the wedge mechanism 6 in place. In an embodiment, this may be detected by one or more sensors. Since the wedge mechanism 6 is locked in place, upon upward movement of the lever 2 the wedge mechanism 6 cannot rotate and the tab engagement finger 8 pulls up on the tab 14 as the lever 2 moves upward, thereby opening the beverage can 12.

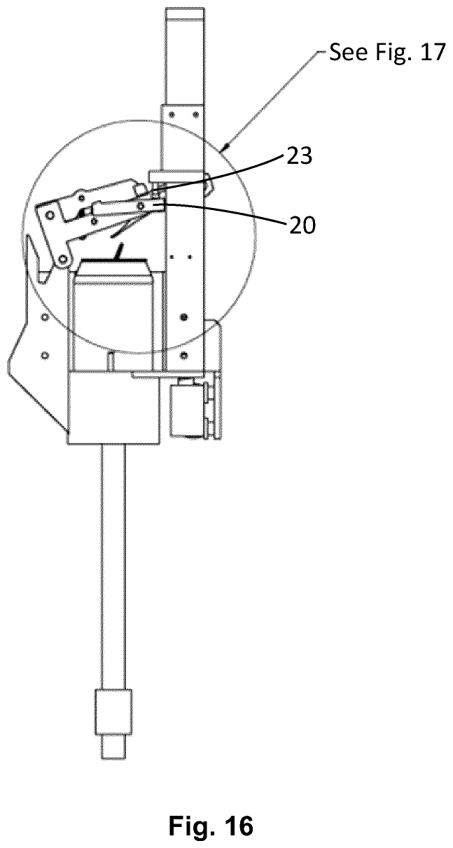

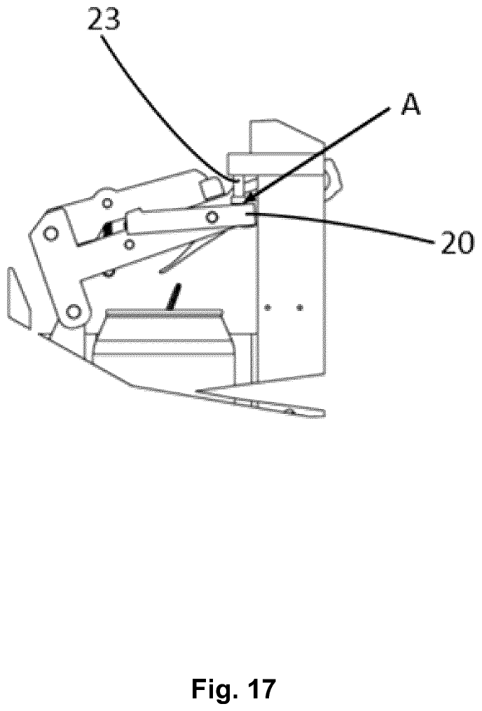

In FIGS. 16 & 17, the lever 2 continues to move upward away from the top of the beverage can 12 until an unlocker 20 contacts a stopper 23 on the stand apparatus 18 (see A in FIG. 17). Movement of the lever 2 upwards remains an automated process. As can be seen, upward movement of lever 2 disengages the tab engagement finger 8 from the tab 14 since it is moved above the reach of the tab 14.

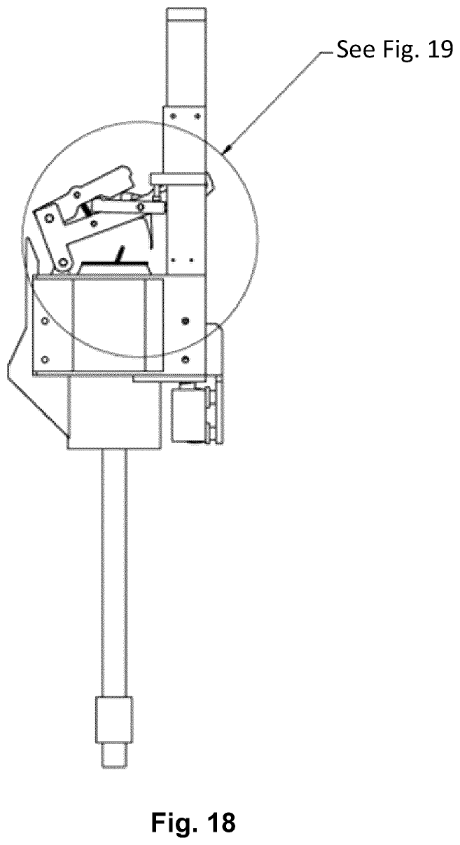

In FIGS. 18 & 19, upon contacting the stopper 23, the unlocker 20 disengages the locker 16, thereby restoring the wedge mechanism 6 to its original position, whereby the automatic beverage can opener 1 is armed for the next beverage can 12. In the embodiment of FIGS. 1-19, it can be seen that the unlocker 20 pivots about an unlocker pivot axis 24. In this embodiment of FIGS. 1-19, the unlocker pivot axis 24 is formed by attaching the unlocker 20 to the same pivot bar 17 onto which the wedge mechanism 6 is suspended.

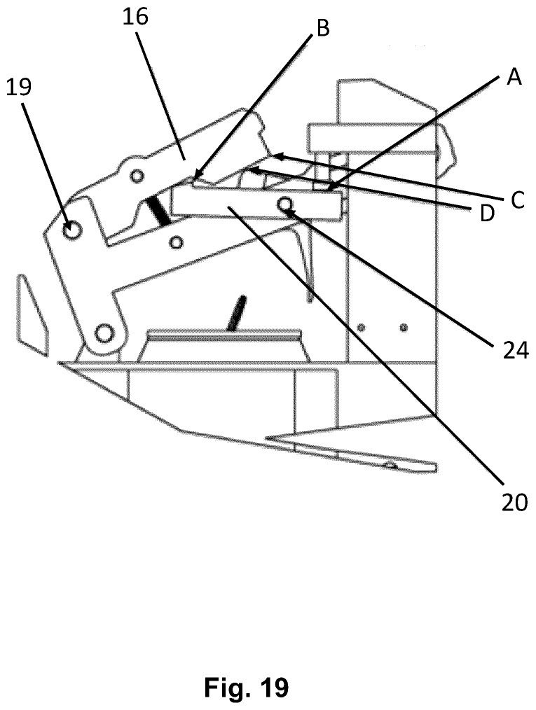

In operation, when the unlocker 20 contacts the stopper 23, the stopper 23 forces the unlocker 20 to pivot about the unlocker pivot axis 24. This pivoting of the unlocker 20 causes the opposite end of the unlocker 20 to push up against a bottom surface of the locker 16 (see B in FIG. 19). Upward movement of the locker 16 releases the underside portion 21 of the wedge mechanism 6 from its locked position against the edge of the end of the locker 16 distal to the locker pivot axis 19 (edge C in FIG. 19). This allows the wedge mechanism 6 to rotate back to its original position. In the embodiments of FIGS. 1-19, the wedge mechanism 6 is biased to rotate back to its original position (i.e. where the tab engagement finger 8 is in a downwardly pointing state) by a wedge spring 25 that is attached at one end to the lever spring bar 26 on the lever 2 and at the other end to the wedge mechanism 6. Back in its original position, the lock prevention edge 9 of the wedge mechanism 6 is again positioned to prevent the locker 16 from engaging in a locked position (see D in FIG. 19). Thus, the wedge mechanisn is free to rotate and the automatic beverage can opener 1 is armed for the next beverage can 12.

Another embodiment of an automatic beverage can opener 100 is shown in FIG. 20. In contrast to the above-described embodiment, in automatic beverage can opener 100 the can holder 110 and flat platform 111 on which the beverage can 12 sits do not include components for rotation of the beverage can 12. The automatic beverage can opener 100 includes separate operational compartments, including a lift 150, a funnel 160, a rotation module 170, and a can opening module 180.

The lift module 150 includes the can holder 110 and the flat platform 111. In the embodiment of automatic beverage can opener 100, neither of these components performs a function of rotating the beverage can 12. In operation, a beverage can 12 is inserted into the funnel module 160 (e.g. from a beverage storage compartment of a vending machine) to rest atop the flat platform 111 of the lift module 150. In an embodiment, within the lift module 150, a lift platform 151 may be interconnected to the can holder 110. Upward and downward movement of the lift platform 151, e.g. along a track system, threaded mechanism or the like 152, can function to lift the can holder 110 and the flat platform 111, and thereby lift the beverage can 12 sitting on the flat platform 111 into the rotation module 170.

Many different configurations of the lift module 150 and the funnel module 160 can be envisioned having regard to the present disclosure. The skilled person would be well-aware of alternate configurations that could be used for lifting the beverage can 12 into the rotation module 170. In some embodiments, the functions of the lift module 150 and funnel module 160 may be combined into a single module. In some embodiments, a lift apparatus may not be needed if the beverage is directly delivered to the rotation module 170 at an appropriate operational height.

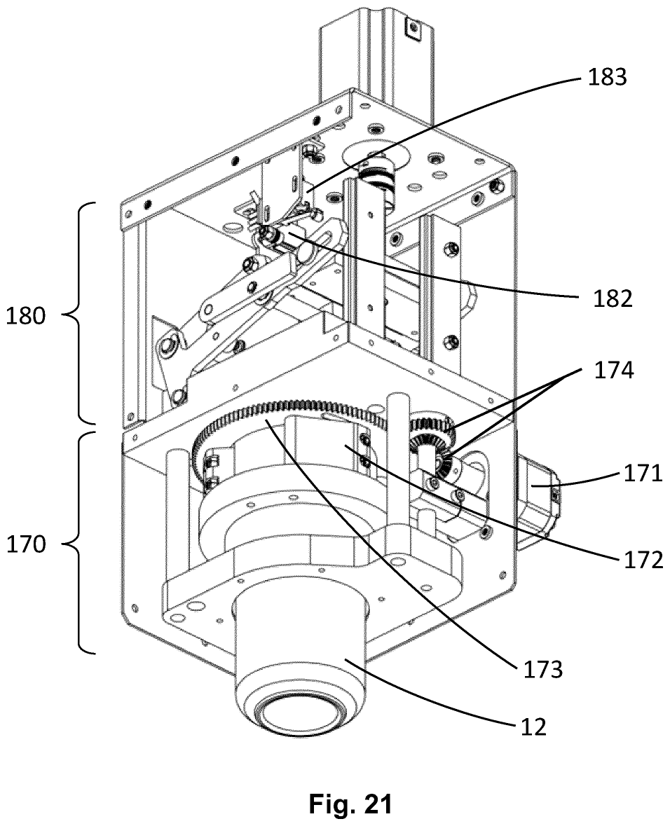

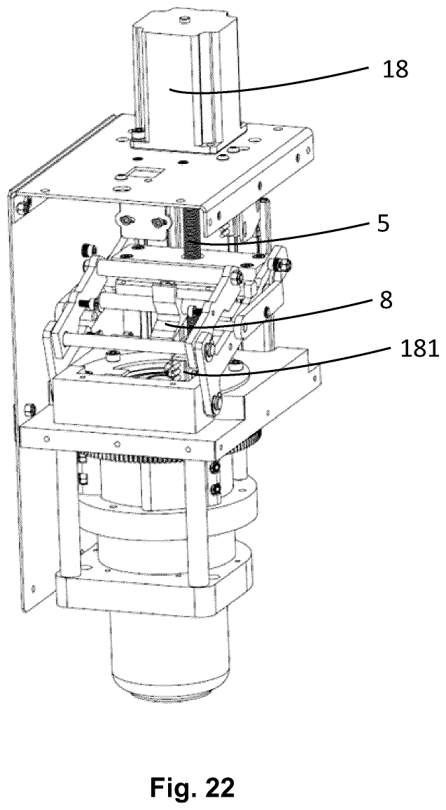

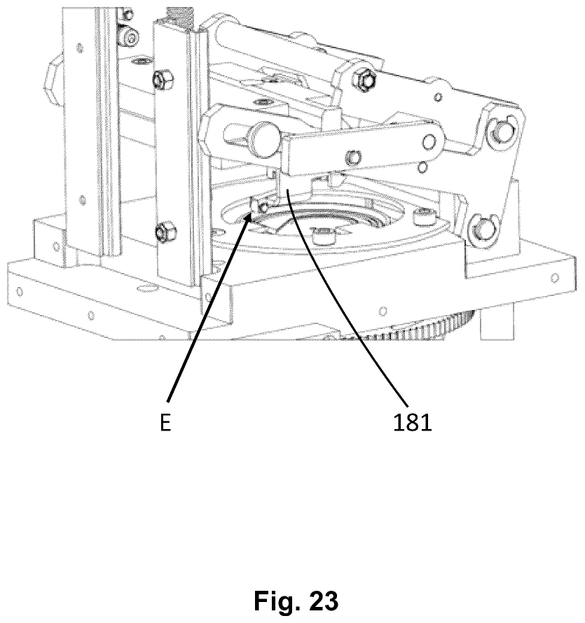

FIG. 21 is an extracted view of only the rotation module 170 and the can opening module 180 of the automatic beverage can opener 100, with some of the side panels of FIG. 20 removed. In operation, the beverage can 12 is lifted or placed into the rotation module 170 by suitable means, such as described herein. In the embodiment of FIGS. 20-23, a first limit switch sensor 181 capable of indexing against the top rim of the beverage can 12 is used to accurately position the beverage can 12 at an opening height. The first limit switch sensor is seen in FIG. 22 within the can opening module 180 and in FIG. 23 an arm of the first limit switch sensor 181 can be seen in contact with the top rim of the beverage can 12 (see E in FIG. 23). During automated operation, the beverage can 12 would be lifted into the rotation module 170 until the top rim contacts the first limit switch sensor 181, triggering the lift platform 151 to stop lifting the beverage can 12. Other types of sensors or mechanisms may be used for the automated lifting procedure.

Once the beverage can 12 is positioned at the opening height, it must be rotated to align the tab 14 with the tab engagement finger 8. Detection of the location of the tab 14 can be handled as described elsewhere herein.

In the embodiment of the automatic beverage can opener 100, positioning of the beverage can 12 at the opening height within the rotation module 170 triggers motor 171 into operation. As shown in the embodiment of FIG. 21, motor 171 is operationally interconnected to a 3-jaw chuck 172 through a geared mechanism, including a chuck gear 173. Activation of motor 171 functions to turn chuck gear 173, either directly or indirectly through other geared components 174. Initial turning of chuck gear 173 causes the individual jaws of the 3-jaw chuck 172 to move inwards and engage against the side of the beverage can 12. Advantageously, it has been found that once the jaws of the 3-jaw chuck 172 engage the beverage can 12, continued rotation of the chuck gear 173 can be used to rotate the beverage can 12. Thus, a separate rotation mechanism for the beverage can 12 is not needed.

The exemplary embodiments in FIGS. 20-23 employ a 3-jaw chuck 172. However, it will be well understood that alternate jaw chucks (e.g. a 4-jaw chuck) may be used or an entirely different mechanism could be used to rotate the beverage can 12 within the rotation module 170. These alternatives would be apparent to the skilled person having regard to the present disclosure.

In the embodiment of the automatic beverage can opener 100, to determine the appropriate rotation of the beverage can 12 to align the tab 14 with the tab engagement finger 8, a laser sensor 182 may be used. As shown in FIG. 21, a laser sensor 182 may be positioned within the can opening module 180. The laser of the laser sensor 182 is directed downwards towards the top of the beverage can 12. As the beverage can 12 is rotated in the rotation module 170, the laser sensor 182 detects differences in the height of features at the top of the beverage can 12. The laser sensor 182 is capable of detecting the location of the tab 14 and through automated controls, the beverage can 12 is rotated to align the tab 14 with the tab engagement finger 8.

Once the tab 14 of the beverage can 12 is aligned with the tab engagement finger 8, operation of automatic beverage can opener 100 for opening the beverage can 12 may be similar to the process described earlier herein. As shown in FIG. 21, a second limit switch sensor 183 may be positioned with the can opening module 180 to act as a stop indicator for upward motion of lever 2.

The skilled person will appreciate that exemplary embodiments and features of the automatic beverage can opener of the present disclosure has been described. Many obvious variations of the embodiments set out herein will suggest themselves to those skilled in the art in light of the present disclosure. Such obvious variations are within the full intended scope of the present disclosure.

From the disclosure herein relating to the operation of an exemplary automatic beverage can opener, it will further be appreciated that the present disclosure provides a method for automatically opening a beverage can, the method comprising employing the automatic beverage can opener as disclosed herein.

More particularly, in an embodiment, the present disclosure provides a method for automatically opening a beverage can, the method comprising: automated delivery of a beverage can to a can holder and/or a rotation module upon an activation signal; automated detection of a tab on the top of the beverage can and alignment of the tab with a tab engagement finger of an automatic beverage can opener; automated engagement of the tab engagement finger with the beverage can by activation and downward movement of a lever of the automatic beverage can opener, whereby upon contact with the beverage can the tab engagement finger rotates about a wedge rotation axis on the lever to position the tab engagement finger between the top of the beverage can and the tab; automated locking of the tab engagement finger to prevent further rotational movement; and automated upward movement of the lever to open the tab on the beverage can. The steps of the method, and how they performed will be well appreciated from the disclosure herein relating to the automatic beverage can opener and the operation thereof.

In another embodiment, the present disclosure relates to a kit-of-parts for assembling the automatic beverage can opener 1/100, the kit-of-parts comprising: a lever 2, a wedge mechanism 6 having a tab engagement finger 8, and a can holder 10.

In some embodiments, the kit-of-parts may further comprise a rotation module 170, a locker 16, a stand apparatus 18, an unlocker 20, one or more side wall supports 22, or any combination thereof.

In another embodiment, the present disclosure relates to a vending machine comprising the automatic beverage can opener 1/100 of the present disclosure. In an embodiment, the vending machine dispenses alcoholic beverages, for example for use at a sports event.

In the present disclosure, all terms referred to in singular form are meant to encompass plural forms of the same. Likewise, all terms referred to in plural form are meant to encompass singular forms of the same. Unless defined otherwise, all technical and scientific terms used herein have the same meaning as commonly understood by one of ordinary skill in the art to which this disclosure pertains.

As used herein, the term “about” refers to an approximately +/−10% variation from a given value. It is to be understood that such a variation is always included in any given value provided herein, whether or not it is specifically referred to.

It should be understood that the compositions and methods are described in terms of “comprising,” “containing,” or “including” various components or steps, the compositions and methods can also “consist essentially of or “consist of the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are discussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents that may be referenced herein, the definitions that are consistent with this specification should be adopted.

Many obvious variations of the embodiments set out herein will suggest themselves to those skilled in the art in light of the present disclosure. Such obvious variations are within the full intended scope of the appended claims.

1. An automatic beverage can opener comprising:
a lever, the lever being automated and movable about a lever pivot axis;
a wedge mechanism that is rotatably interconnected to the lever, the wedge mechanism comprising a tab engagement finger; and
a can holder and/or rotation module for positioning a beverage can in a position where a tab thereof can be engaged by the tab engagement finger upon automated movement of the lever.

2. The automatic beverage can opener of claim 1, wherein the lever pivot axis is at or near a first end of the lever.

3. The automatic beverage can opener of claim 1, wherein,
in operation, as a second end of the lever distal to the lever pivot axis is moved downward towards the beverage can, the tab engagement finger contacts a top of the beverage can and by rotational movement of the wedge mechanism the tab engagement finger is positioned between the top of the beverage can and the tab.

4. The automatic beverage can opener of claim 3, wherein, in operation, as the lever is moved upward at the second end away from the beverage can, the tab engagement finger opens the tab of the beverage can.

5. The automatic beverage can opener of claim 1, further comprising a locker for locking the tab engagement finger in a locked configuration when the tab engagement finger is positioned between the top of the beverage can and the tab.

6. The automatic beverage can opener of claim 5, wherein the locker is pivotedly connected to the lever at a locker pivot axis, wherein the lever pivot axis and the locker pivot axis are proximate each other on the lever.

7. The automatic beverage can opener of claim 5, wherein, in operation, prior to contact with the top of the beverage can, the tab engagement finger is oriented in a downward pointing direction and a lock prevention edge on an opposite end of the wedge mechanism prevents locking of the locker.

8. The automatic beverage can opener of claim 7, wherein, in operation, rotational movement of the wedge mechanism upon contact with the top of the beverage can moves the lock prevention edge out from under the locker to allow the locker to pivot about the locker pivot axis and put the tab engagement finger in the locked configuration.

9. The automatic beverage can opener of claim 5, wherein when the tab engagement finger is in the locked configuration, the locker prevents further rotational movement of the tab engagement finger.

10. The automatic beverage can opener of claim 9, wherein the locker prevents further rotational movement of the tab engagement finger by an end of the locker distal to the locker pivot axis abutting against an underside portion of the wedge mechanism.

11. The automatic beverage can opener of claim 5, further comprising an unlocker for unlocking the tab engagement finger from the locked configuration.

12. The automatic beverage can opener of claim 11, wherein the unlocker is pivotedly connected to the lever at an unlocker pivot axis and is configured to unlock the locker upon pivotal rotation about the unlocker pivot axis.

13. The automatic beverage can opener of claim 12, wherein a first portion of the unlocker is positioned under the locker.

14. The automatic beverage can opener of claim 13, wherein, in operation, after the tab has been opened and the lever moves upward, a second portion of the unlocker contacts a stopper causing rotation of the unlocker about the unlocker pivot axis to push the first portion of the unlocker upwards to unlock the locker.

15. The automatic beverage can opener of claim 1, further comprising a stand apparatus operably connected to the lever at the lever pivot axis and at the opposite end of the lever to provide automated movement of the lever.

16. The automatic beverage can opener of claim 15, wherein the stand apparatus comprises a threaded rod and a threaded platform, wherein the lever is operably connected to the threaded platform distal to the lever pivot axis.

17. The automatic beverage can opener of claim 15, wherein the can holder and/or the rotation module are operably interconnected to the stand at a position below the lever.

18. The automatic beverage can opener of claim 1, wherein the can holder and/or rotation module are configured for holding variety of different beverage can sizes.

19. The automatic beverage can opener of claim 1, wherein the can holder comprises a flat platform on which the beverage can sits, and the flat platform comprises two or more prongs, each prong being retractable and extendable relative to a center position on the flat platform for engaging the beverage can.

20. The automatic beverage can opener of claim 1, wherein, in operation, the can holder or a component thereof rotates the beverage can to align the tab with the tab engagement finger.

21. The automatic beverage can opener of claim 1, wherein, in operation, the can holder lifts the can to position it within the rotation module of the automatic beverage can opener.

22. The automatic beverage can opener of claim 1, wherein the rotation module comprises a jaw chuck and a chuck gear.

23. The automatic beverage can opener of claim 22, wherein, in operation, rotation of the chuck gear in a first phase engages the jaws of the jaw chuck against the beverage can and in a second phase rotates the beverage can.

24. The automatic beverage can opener of claim 1, further comprising one or more sensors for automated operation.

25. The automatic beverage can opener of claim 24, wherein the one or more sensors are for positioning the beverage can at an opening height and/or detecting the orientation or alignment of the tab with the tab engagement finger.

26. The automatic beverage can opener of claim 25, which comprises a limit switch sensor for positioning the beverage can at an opening height.

27. The automatic beverage can opener of claim 26, wherein the limit switch sensor indexes the position of a top rim of the beverage can for automated positioning of the beverage can at the opening height.

28. The automatic beverage can opener of claim 1, which comprises a laser sensor or an optical sensor for detecting the orientation or alignment of the tab with the tab engagement finger.

29. The automatic beverage can opener of claim 1, wherein during automated movement of the lever to open the tab, the beverage can remains stationary.

30. (canceled)

31. The automatic beverage can opener of claim 1, which automatically opens the beverage can without human interaction.

32. The automatic beverage can opener of claim 1, which automatically detects placement of the beverage can on the can holder and/or within the rotation module, height position of the beverage can, location of the tab on the top of the beverage can, orientation or alignment of the tab with the tab engagement finger, locking of the tab engagement finger underneath the tab, unlocking of the tab engagement finger, upper travel limit of the lever being reached, or any combination thereof.

33. The automatic beverage can opener of claim 1, which is capable of:
automatically disengaging the beverage can and resetting to a start position in the same movement as the opening of the tab of the beverage can; and/or
discarding beverage cans with issues.

34. (canceled)

35. The automatic beverage can opener of claim 1, further comprising one or more side wall supports for surrounding at least a portion of the beverage can.

36.-41. (canceled)

42. A vending machine comprising the automatic beverage can opener of claim 1.
